(19) United States
(12) Patent Application Publication
(10) Pub. No.: US 2022/0302468 A1
(43) Pub. Date: Sep. 22, 2022

(54) ELECTRODE CATALYST FOR ELECTROCHEMICAL DEVICE, ELECTRODE CATALYST LAYER FOR ELECTROCHEMICAL DEVICE, MEMBRANE/ELECTRODE ASSEMBLY, AND ELECTROCHEMICAL DEVICE

(71) Applicant: Panasonic Intellectual Property Management Co., Ltd., Osaka (JP)

(72) Inventors: RYO KODA, Osaka (JP); HARUHIKO SHINTANI, Osaka (JP)

(21) Appl. No.: 17/805,700

(22) Filed: Jun. 7, 2022

Related U.S. Application Data
(63) Continuation of application No. PCT/JP2020/042353, filed on Nov. 13, 2020.

(30) Foreign Application Priority Data
Dec. 27, 2019 (JP) 2019-239228
Oct. 29, 2020 (JP) 2020-181825

(51) Int. Cl. H01M 4/96; H01M 8/1004; H01M 4/86; H01M 4/90

(52) U.S. Cl. CPC H01M 4/96; H01M 8/1004; H01M 4/8605; H01M 4/9075

(57) ABSTRACT

An electrode catalyst for an electrochemical device, the electrode catalyst including: mesoporous carbon particles having an average crystallite size along a 002 plane of greater than or equal to 1.6 nm and less than or equal to 3.4 nm; and catalyst metal particles supported on the mesoporous carbon particles. The mesoporous carbon particles have an average particle diameter of primary particles of greater than or equal to 500 nm.

### BACKGROUND

### 1. Technical Field

The present disclosure relates to an electrode catalyst for an electrochemical device and to an electrode catalyst layer for an electrochemical device. The present disclosure also relates to a membrane/electrode assembly and an electrochemical device.

### 2. Description of the Related Art

Electrode catalysts known in the related art include the electrode catalysts disclosed in Japanese Unexamined Patent Application Publication No. 2018-181838 and Japanese Patent No. 6063039. In these electrode catalysts, a catalyst metal is supported within mesoporous carbon.

### SUMMARY

However, there is still room for improvement in the related-art technologies described in Japanese Unexamined Patent Application Publication No. 2018-181838 and Japanese Patent No. 6063039 in terms of durability necessary for electrochemical reactions in electrochemical devices (hereinafter referred to as “device durability”).

The present disclosure is designed to solve the problem associated with the related-art technologies. Accordingly, non-limiting and exemplary embodiments herein provide an electrode catalyst for an electrochemical device, an electrode catalyst layer for an electrochemical device, a membrane/electrode assembly, and an electrochemical device that have high device durability.

According to an aspect of the present disclosure, an electrode catalyst for an electrochemical device, the electrode catalyst includes: mesoporous carbon particles having an average crystallite size along a 002 plane of greater than or equal to 1.6 nm and less than or equal to 3.4 nm; and catalyst metal particles supported on the mesoporous carbon particles. The mesoporous carbon particles have an average particle diameter of primary particles of greater than or equal to 500 nm.

According to another aspect of the present disclosure, an electrode catalyst layer for an electrochemical device includes an electrode catalyst and a proton conductive resin, and the electrode catalyst includes: mesoporous carbon particles having an average crystallite size along a 002 plane of greater than or equal to 1.6 nm and less than or equal to 3.4 nm; and catalyst metal particles supported on the mesoporous carbon particles. The mesoporous carbon particles have an average particle diameter of primary particles of greater than or equal to 500 nm.

According to yet another aspect of the present disclosure, a membrane/electrode assembly includes a proton conductive electrolyte membrane, an anode provided on a first major surface of the proton conductive electrolyte membrane, and a cathode provided on a second major surface of the proton conductive electrolyte membrane, wherein at least one selected from the group consisting of the anode and the cathode includes an electrode catalyst layer. The electrode catalyst layer includes an electrode catalyst and a proton conductive resin, and the electrode catalyst includes: mesoporous carbon particles having an average crystallite size along a 002 plane of greater than or equal to 1.6 nm and less than or equal to 3.4 nm; and catalyst metal particles supported on the mesoporous carbon particles. The mesoporous carbon particles have an average particle diameter of primary particles of greater than or equal to 500 nm.

According to still another aspect of the present disclosure, an electrochemical device includes a membrane/electrode assembly, and the membrane/electrode assembly includes a proton conductive electrolyte membrane, an anode provided on a first major surface of the proton conductive electrolyte membrane, and a cathode provided on a second major surface of the proton conductive electrolyte membrane, wherein at least one selected from the group consisting of the anode and the cathode includes an electrode catalyst layer. The electrode catalyst layer includes an electrode catalyst and a proton conductive resin, and the electrode catalyst includes: mesoporous carbon particles having an average crystallite size along a 002 plane of greater than or equal to 1.6 nm and less than or equal to 3.4 nm; and catalyst metal particles supported on the mesoporous carbon particles. The mesoporous carbon particles have an average particle diameter of primary particles of greater than or equal to 500 nm.

The present disclosure produces an effect of realizing an electrode catalyst for an electrochemical device, an electrode catalyst layer for an electrochemical device, a membrane/electrode assembly, and an electrochemical device that have high device durability.

The above and other objects, features, and advantages of the present disclosure will become apparent from the following detailed description of suitable embodiments taken in conjunction with the accompanying drawings.

### BRIEF DESCRIPTION OF THE DRAWINGS

FIG. 1 is a schematic diagram illustrating an example of an electrode catalyst for an electrochemical device according to a first embodiment;

FIG. 2A is a schematic diagram illustrating an example of an electrode catalyst layer for an electrochemical device according to a second embodiment, and FIG. 2B is a partially enlarged view of FIG. 2A;

FIG. 3 is a schematic diagram illustrating an example of a membrane/electrode assembly according to a third embodiment;

FIG. 4 is a schematic diagram illustrating an example of an electrochemical device according to a fourth embodiment;

FIG. 5 is a graph illustrating a relationship between an average crystallite size along a 002 plane of mesoporous carbon particles and a decrease in voltage resulting from a potential cycling test performed on a fuel cell;

FIG. 6 is a graph illustrating a relationship between a DTA peak temperature and a particle diameter regarding mesoporous carbon particles having an average crystallite size along a 002 plane of 0.8 nm;

FIG. 7 is a graph illustrating a relationship between a DTA peak temperature and a particle diameter regarding mesoporous carbon particles having an average crystallite size along a 002 plane of 2.2 nm; and

FIG. 8A is an image of a cross section of a mesoporous carbon particle before a potential cycling test, the mesoporous carbon particle having an average crystallite size along a 002 plane of 0.8 nm, FIG. 8B is an image of the cross section of the mesoporous carbon particle after the potential cycling test, the mesoporous carbon particle having an average crystallite size along a 002 plane of 0.8 nm, and FIG. 8C is an image of a cross section of a mesoporous carbon particle after the potential cycling test, the mesoporous carbon particle having an average crystallite size along a 002 plane of 2.2 nm.

### DETAILED DESCRIPTIONS

### Underlying Knowledge Forming Basis of the Present Disclosure

The present inventors diligently performed studies on the device durability of electrode catalysts for an electrochemical device. As a result, it was discovered that an average crystallite size along a 002 plane of mesoporous carbon used as a support in an electrode catalyst of an electrochemical device affects the device durability of the electrochemical device.

Specifically, as stated in Japanese Patent No. 6063039, it has been believed that a large crystallite size along a 002 plane is not appropriate because if the crystallite size is large, mesopores of the mesoporous carbon collapse during a heat treatment, depending on temperature.

However, the present inventors discovered that for the device durability of an electrochemical device with respect to the startup and shutdown of fuel cell systems, a large average crystallite size along a 002 plane is appropriate. Specifically, the present inventors discovered that an average crystallite size along a 002 plane of greater than or equal to 1.6 nm is appropriate for ensuring that the device durability achieved by the use of an electrode catalyst that includes mesoporous carbon particles as a support is comparable to or better than the device durability achieved by the use of an electrode catalyst that includes carbon black as a support. The present disclosure has been made based on this knowledge. Accordingly, the present disclosure specifically provides aspects as described below.

According to a first aspect of the present disclosure, an electrode catalyst for an electrochemical device, the electrode catalyst includes: mesoporous carbon particles having an average crystallite size along a 002 plane of greater than or equal to 1.6 nm and less than or equal to 3.4 nm; and catalyst metal particles supported on the mesoporous carbon particles. The mesoporous carbon particles have an average particle diameter of primary particles of greater than or equal to 500 nm.

With this configuration, the electrode catalyst has high electrochemical durability and, therefore, has high device durability.

According to a second aspect of the present disclosure, the electrode catalyst for an electrochemical device of the first aspect is one in which mesopores present in the mesoporous carbon particles have a mode radius of greater than or equal to 1 nm and less than or equal to 25 nm and a pore volume of greater than or equal to 1.0 cm³/g and less than or equal to 3.0 cm³/g before the catalyst metal particles are supported on the mesoporous carbon particles. With this configuration, the electrode catalyst has high catalytic activity and durability.

According to a third aspect of the present disclosure, an electrode catalyst layer for an electrochemical device includes the electrode catalyst of the first or second aspect and a proton conductive resin. With this configuration, the electrode catalyst layer has high device durability because the electrode catalyst layer includes the electrode catalyst described above.

According to a fourth aspect of the present disclosure, a membrane/electrode assembly includes a proton conductive electrolyte membrane, an anode provided on a first major surface of the proton conductive electrolyte membrane, and a cathode provided on a second major surface of the proton conductive electrolyte membrane, wherein at least one selected from the group consisting of the anode and the cathode includes the electrode catalyst layer of the third aspect. With this configuration, the membrane/electrode assembly has high device durability because the membrane/electrode assembly includes the electrode catalyst layer described above.

According to a fifth aspect of the present disclosure, the membrane/electrode assembly of the fourth aspect is one in which at least the cathode includes the electrode catalyst layer. With this configuration, the membrane/electrode assembly has high device durability because the membrane/electrode assembly includes the electrode catalyst layer described above.

According to a sixth aspect of the present disclosure, an electrochemical device includes the membrane/electrode assembly of the fourth or fifth aspect. With this configuration, the electrochemical device has high device durability because the electrochemical device includes the membrane/electrode assembly described above.

Embodiments of the present disclosure will now be described with reference to the drawings. Note that in the following description, like reference characters designate like or corresponding components throughout the drawings, and redundant descriptions thereof may be omitted.

### First Embodiment

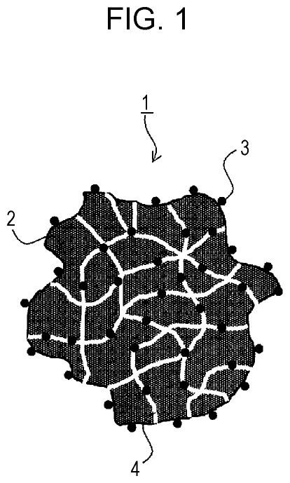

According to a first embodiment of the present disclosure, an electrode catalyst 1 for an electrochemical device includes mesoporous carbon particles 2 and catalyst metal particles 3, as illustrated in FIG. 1. In the following description, an example of the electrochemical device is a fuel cell. Note that the electrochemical device is not limited to fuel cells as long as the device is one in which an electrochemical reaction takes place. For example, the electrochemical device may be a water electrolysis device for electrolyzing water to produce hydrogen and oxygen.

The mesoporous carbon particles 2 are a porous material having a large number of mesopores 4 and are a support on which the catalyst metal particles 3 are supported. The mesoporous carbon particles 2 are produced, for example, by heat-treating mesoporous carbon. A pore structure of the mesoporous carbon is desirably controlled, for example, by changing production conditions, such as a template, a carbon source, and a reaction temperature for the synthesis.

The mesoporous carbon particles 2 have an average particle diameter of primary particles of greater than or equal to 500 nm, for example. The average particle diameter is a median diameter (d50) of a particle size distribution of the mesoporous carbon particles 2. When the average particle diameter is greater than or equal to 500 nm as mentioned, oxidation durability of the electrode catalyst 1 is increased to a level equal to or greater than that of typical electrode catalysts that use carbon black as a support, and, consequently, the device durability of the electrode catalyst 1 is improved. Furthermore, even in instances where the mesoporous carbon particles 2 come into contact with a proton conductive resin, a proportion of the catalyst metal particles 3 that are covered by the proton conductive resin is small, and, consequently, a decrease in the catalytic activity of the electrode catalyst 1 is reduced.

The average particle diameter of the mesoporous carbon particles 2 may be adjusted by using a milling process. The milling process is carried out by performing a method that uses, for example, a roller mill, a ball mill, a bead mill, or the like. Among these, a roller mill may be used, a ball mill may be suitably used, or a bead mill may be more suitably used, to obtain finely ground mesoporous carbon particles 2.

Note that, for example, in a bead mill, the particle diameter of the mesoporous carbon particles 2 is controlled by a speed (peripheral speed) and time of rotation of a stirring mechanism and a diameter of the beads. The peripheral speed is greater than or equal to 6 m/s and less than or equal to 18 m/s. The peripheral speed may be greater than or equal to 8 m/s and less than or equal to 16 m/s or suitably may be greater than or equal to 10 m/s and less than or equal to 14 m/s. The time of rotation of the stirring mechanism may be greater than or equal to 10 minutes and less than or equal to 30 minutes, greater than or equal to 14 minutes and less than or equal to 26 minutes, or greater than or equal to 18 minutes and less than or equal to 22 minutes.

The average particle diameter of the mesoporous carbon particles 2 is measured by using a measurement instrument and/or an observation instrument. Examples of the measurement instrument include laser diffraction particle size distribution analyzers; these analyzers are used in a state in which the mesoporous carbon particles 2 are dispersed in a solvent. Examples of the observation instrument include scanning electron microscopes (SEM) and transmission electron microscopes (TEM).

The mesopores 4 are pores provided in the mesoporous carbon particles 2. The mesopores 4 are open on an exterior surface of the mesoporous carbon particles 2 and extend, from the opening, a long length within the mesoporous carbon particles 2. The mesopores 4 are connected pores and are connected to one or more other mesopores 4. Thus, the multiple mesopores 4 communicate with one another.

The mesopores 4 have a mode radius of greater than or equal to 1 nm and less than or equal to 25 nm before the catalyst metal particles 3 are supported on the mesoporous carbon particles 2. The mode radius is the most frequent radius (radius corresponding to a maximum value) in a size distribution of the mesopores 4 of the mesoporous carbon particles 2. The radius of the mesopores 4 is half a dimension of the mesopores 4 in a direction perpendicular to a direction in which the mesopores 4 extend.

Note that the mode radius of the mesopores 4 may be greater than or equal to 3 nm and less than or equal to 6 nm or suitably may be greater than or equal to 3 nm and less than or equal to 4 nm. When the mode radius of the mesopores 4 is greater than or equal to 3 nm, a gas can readily flow through the mesopores 4. When the mode radius is less than or equal to 6 nm, a proton conductive resin cannot easily penetrate into the mesopores 4 even if the proton conductive resin comes into contact with the electrode catalyst 1.

The mesopores 4 may have a pore volume of greater than or equal to 1.0 cm³/g and less than or equal to 3.0 cm³/g before the catalyst metal particles 3 are supported on the mesoporous carbon particles 2. When the pore volume of the mesopores 4 is greater than or equal to 1.0 cm³/g, a large number of catalyst metal particles 3 can be supported within the mesoporous carbon particles 2 (i.e., in the mesopores 4), and, consequently, the electrode catalyst 1 has high catalytic activity. When the pore volume of the mesopores 4 is less than or equal to 3.0 cm³/g, the mesoporous carbon particles 2, as a structure body, have high strength.

Note that the pore volume and the mode radius of the mesopores 4 can be determined by analyzing measured data of a nitrogen adsorption and desorption isotherm. Examples of methods for the analysis include Barrett-Joyner-Halenda (BJH) methods, density functional theory (DFT) methods, and quenched solid density functional theory (QSDFT) methods.

The mesoporous carbon particles 2 have an average crystallite size along a 002 plane of greater than or equal to 1.6 nm. As a result, electrochemical durability of the electrode catalyst 1 is increased to a level equal to or greater than that of typical electrode catalysts in which carbon black is used as a support. Consequently, the device durability achieved by the use of the electrode catalyst 1 that includes the mesoporous carbon particles 2 as a support is comparable to or better than the device durability achieved by the use of an electrode catalyst that includes carbon black as a support, that is, the electrode catalyst 1 has high device durability.

The average crystallite size along a 002 plane is controlled, for example, with a temperature for heat treatment of the mesoporous carbon. The temperature for heat treatment of the mesoporous carbon is greater than or equal to 1000° C. and less than 2000° C. The temperature for heat treatment may be greater than or equal to 1400° C. and less than 1700° C. or suitably may be greater than or equal to 1600° C. and less than 1680° C.

The mesoporous carbon particles 2 have a specific surface area of greater than or equal to 1000 m²/g. The specific surface area is a surface area per unit weight of the mesoporous carbon particles 2. The surface area of the mesoporous carbon particles 2 includes an area of a surface (interior surface) of the mesoporous carbon particles 2 that defines the mesopores 4 and also includes an area of a surface (exterior surface) exposed on the exterior of the mesoporous carbon particles 2.

The specific surface area can be determined by evaluating the mesoporous carbon particles 2 by using a Brunauer-Emmett-Teller (BET) method, for example. In the BET method, the BET equation is applied, for example, to a region of relative pressures ranging from 0.05 to 0.35 in a nitrogen adsorption and desorption isotherm, and, accordingly, the surface area of the mesoporous carbon particles 2 can be determined.

In the instance in which the mesoporous carbon particles 2 have a specific surface area of greater than or equal to 1000 m²/g, aggregation of the catalyst metal particles 3 supported on the mesoporous carbon particles 2 is reduced to a greater degree than in an instance in which the mesoporous carbon particles 2 have a specific surface area of less than 1000 m²/g. Consequently, a decrease in the specific surface area of the catalyst metal particles 3 due to aggregation is reduced, which in turn reduces a decrease in the catalytic activity of the electrode catalyst 1.

The catalyst metal particles 3 are supported on the mesoporous carbon particles 2. The catalyst metal particles 3 are supported at least within the mesoporous carbon particles 2. That is, the catalyst metal particles 3 are supported on the interior surface of the mesoporous carbon particles 2 that defines the mesopores 4. The catalyst metal particles 3 may, but need not, be supported on the exterior surface of the mesoporous carbon particles 2.

Examples of metals that can form the catalyst metal particles 3 include platinum (Pt), ruthenium (Ru), palladium (Pd), iridium (Ir), silver (Ag), and gold (Au). Platinum and alloys thereof are suitable for use in an electrode catalyst 1 for fuel cells because platinum and alloys thereof have high catalytic activity for a redox reaction and, in addition, exhibit good durability in the power generation environment of a fuel cell. Furthermore, a suitable shape of the catalyst metal particles 3 is a particulate shape.

For example, the catalyst metal particles 3 have an average particle diameter of greater than or equal to 1 nm and less than or equal to 20 nm. The average particle diameter may be greater than or equal to 2 nm and less than or equal to 10 nm. When the average particle diameter of the catalyst metal particles 3 is less than or equal to 10 nm, the catalyst metal particles 3 have a high surface area (specific surface area) per unit weight and, therefore, have high catalytic activity. Furthermore, when the average particle diameter of the catalyst metal particles 3 is greater than or equal to 1 nm, the catalyst metal particles 3 are chemically stable and, therefore, for example, are not easily dissolved even in the power generation environment of a fuel cell.

### Second Embodiment

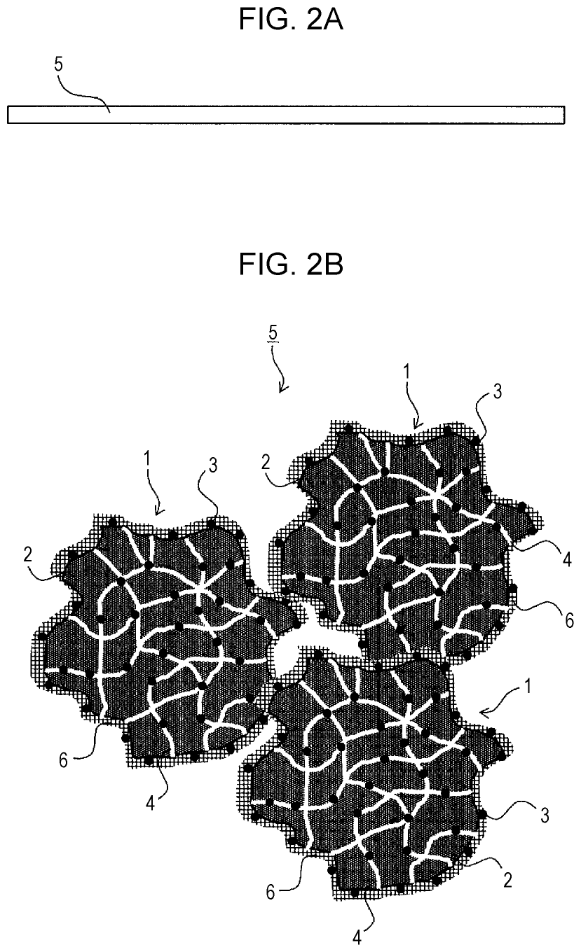

According to a second embodiment of the present disclosure, an electrode catalyst layer 5 for an electrochemical device includes a plurality of particles of the electrode catalyst 1 of the first embodiment and includes a proton conductive resin 6, as illustrated in FIG. 2A and FIG. 2B. For example, the electrode catalyst layer 5 may be a thin film and have a planar shape with a small thickness.

The proton conductive resin 6 is a polymer electrolyte that covers an exterior surface of the electrode catalyst 1 and has proton conductivity. For example, the proton conductive resin 6 is formed of an ion exchange resin, examples of which include ionomers. Among ion exchange resins, a perfluorosulfonic acid resin has high proton conductivity and stably exists even in an electrochemical reaction in an electrochemical device. Accordingly, a perfluorosulfonic acid resin is suitable for use as the proton conductive resin 6 of the electrode catalyst layer 5. Furthermore, the proton conductivity of the proton conductive resin 6 improves the operational efficiency of an electrochemical device.

The ion exchange resin may have an ion exchange capacity of greater than or equal to 0.9 meq/g dry resin and less than or equal to 2.0 meq/g dry resin. When the ion exchange capacity is greater than or equal to 0.9 meq/g dry resin, the proton conductive resin 6 is likely to have high proton conductivity. When the ion exchange capacity is less than or equal to 2.0 meq/g dry resin, water swelling of the resin is inhibited, and, consequently, gas diffusion in the electrode catalyst layer 5 is unlikely to be impaired.

In the electrode catalyst layer 5, a ratio of a weight of the proton conductive resin 6 to a total weight of carbon, including the mesoporous carbon particles 2, may be greater than or equal to 0.3 and less than or equal to 2.0. Furthermore, the weight ratio may be greater than or equal to 0.6 and less than or equal to 1.5 or suitably may be greater than or equal to 0.8 and less than or equal to 1.2.

Note that the electrode catalyst layer 5 may include an additional carbon material, which may be at least one selected from the group consisting of a carbon black and a carbon nanotube. The carbon material has an average particle diameter less than the average particle diameter of the mesoporous carbon particles 2. For example, the average particle diameter of the carbon material is greater than or equal to 10 nm and less than or equal to 100 nm. The carbon material is disposed between adjacent mesoporous carbon particles 2 to fill the space.

The carbon material, which is a carbon black and/or a carbon nanotube, induces capillary action and, therefore, prevents water from remaining in the space between mesoporous carbon particles 2. Consequently, drainage properties of the electrode catalyst layer 5 are improved, which in turn increases the efficiency of electrochemical reactions in electrochemical devices. Furthermore, the carbon material has conductivity and, therefore, supplements the conductivity between mesoporous carbon particles 2. Consequently, resistance in the electrode catalyst layer 5 is reduced, which in turn increases the efficiency of electrochemical reactions in electrochemical devices.

Furthermore, the electrode catalyst layer 5 may include one or more other materials (e.g., a metal oxide and the like), in addition to the mesoporous carbon particles 2 and the catalyst metal. In this case, electron conductivity, proton conductivity, oxygen diffusion, and the like in the electrode catalyst layer 5 are improved.

As described above, the electrode catalyst layer 5 includes the electrode catalyst 1, which includes the mesoporous carbon particles 2 having an average crystallite size along a 002 plane of greater than or equal to 1.6 nm and includes the catalyst metal particles 3 supported on the mesoporous carbon particles 2. Consequently, the electrode catalyst layer 5 has high device durability.

### Third Embodiment

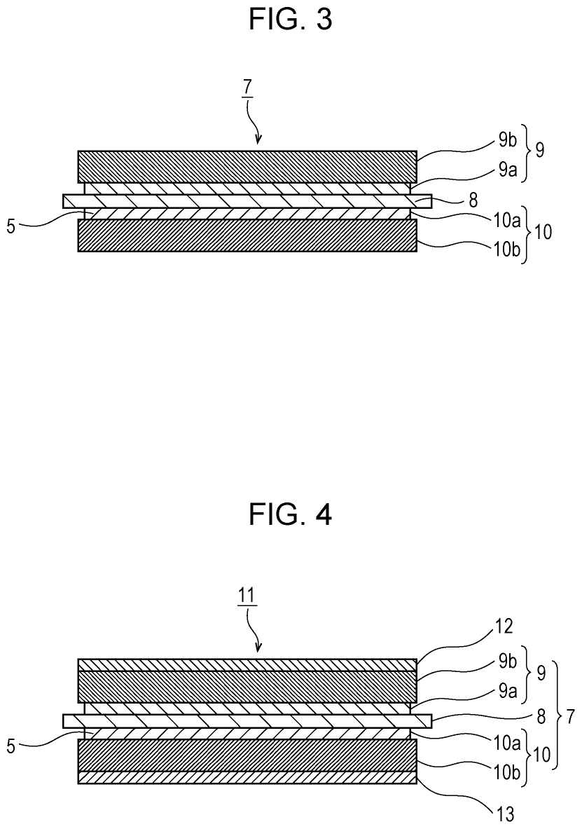

According to a third embodiment of the present disclosure, a membrane/electrode assembly 7 (MEA) includes a proton conductive electrolyte membrane 8, an anode 9, and a cathode 10, as illustrated in FIG. 3. At least one selected from the group consisting of the anode 9 and the cathode 10 includes the electrode catalyst layer 5 for an electrochemical device of the second embodiment. In this regard, at least the cathode 10 may include the electrode catalyst layer 5.

The proton conductive electrolyte membrane 8 has both proton conductivity and a gas barrier property. For example, the proton conductive electrolyte membrane 8 is a solid polymer electrolyte membrane and is formed of an ion exchange fluororesin membrane, an ion exchange hydrocarbon resin membrane, or the like. Among these, a perfluorosulfonic acid resin membrane has high proton conductivity and, for example, can stably exist even in the power generation environment of a fuel cell.

The proton conductive electrolyte membrane 8 is held between the anode 9 and the cathode 10 and conduct ions (protons) between the anode 9 and the cathode 10. The proton conductive electrolyte membrane 8 has an ion exchange capacity of greater than or equal to 0.9 meq/g dry resin and less than or equal to 2.0 meq/g dry resin. When the ion exchange capacity is greater than or equal to 0.9 meq/g dry resin, the proton conductive electrolyte membrane 8 is likely to have high proton conductivity. When the ion exchange capacity is less than or equal to 2.0 meq/g dry resin, water swelling of the resin is inhibited in the proton conductive electrolyte membrane 8, and, consequently, dimensional changes of the proton conductive electrolyte membrane 8 are inhibited.

The proton conductive electrolyte membrane 8 has a pair of surfaces (major surfaces), and a dimension (film thickness) between the surfaces is, for example, greater than or equal to 5 μm and less than or equal to 50 μm. When the film thickness is greater than or equal to 5 μm, the proton conductive electrolyte membrane 8 has a high gas barrier property. When the film thickness is less than or equal to 50 μm, the proton conductive electrolyte membrane 8 has high proton conductivity.

The anode 9 and the cathode 10 are electrodes of the membrane/electrode assembly 7 and hold the proton conductive electrolyte membrane 8 therebetween. The anode 9 is disposed on a first major surface, which is one of the pair of major surfaces of the proton conductive electrolyte membrane 8, and the cathode 10 is disposed on a second major surface, which is the other of the pair of major surfaces.

The anode 9 includes an electrode catalyst layer (first electrode catalyst layer 9a) and a gas diffusion layer (first gas diffusion layer 9b). A first surface of the first electrode catalyst layer 9a is disposed on the first major surface of the proton conductive electrolyte membrane 8, and a first surface of the first gas diffusion layer 9b is disposed on a second surface of the first electrode catalyst layer 9a.

The cathode 10 includes an electrode catalyst layer (second electrode catalyst layer 10a) and a gas diffusion layer (second gas diffusion layer 10b). A first surface of the second electrode catalyst layer 10a is disposed on the second major surface of the proton conductive electrolyte membrane 8, and a first surface of the second gas diffusion layer 10b is disposed on a second surface of the second electrode catalyst layer 10a.

The gas diffusion layers 9b and 10b are layers that have both a current collecting function and gas permeability. For example, each of the gas diffusion layers 9b and 10b is formed of a material that has excellent conductivity and gas/liquid permeability. Examples of the material include porous materials, such as carbon paper, carbon fiber cloths, and carbon fiber felts.

Note that a liquid-repellent layer may be provided between the first gas diffusion layer 9b and the first electrode catalyst layer 9a and between the second gas diffusion layer 10b and the second electrode catalyst layer 10a. The liquid-repellent layer is a layer for improving liquid permeability (drainage properties). Major components that form the liquid-repellent layer are, for example, a conductive material and a liquid-repellent resin. Examples of the conductive material include carbon blacks, and examples of the liquid-repellent resins include polytetrafluoroethylene (PTFE).

The electrode catalyst layers 9a and 10a are layers for accelerating the speed of a power generation reaction at the electrodes. At least one selected from the group consisting of the first electrode catalyst layer 9a and the second electrode catalyst layer 10a includes the electrode catalyst layer 5. Thus, since the anode 9 and/or the cathode 10 include the electrode catalyst layer 5, the membrane/electrode assembly 7 has high device durability.

For example, at least the second electrode catalyst layer 10a may include the electrode catalyst layer 5. In this instance, the first electrode catalyst layer 9a may be formed of the electrode catalyst layer 5 or may have a configuration similar to that of an electrode catalyst layer of the related art typically used in a membrane/electrode assembly 7 of a fuel cell. Furthermore, in this instance, the second electrode catalyst layer 10a is formed of the electrode catalyst layer 5.

For example, the membrane/electrode assembly 7 is prepared in the following manner. A catalyst paste is prepared in which a conductive material, catalyst metal particles 3, and a proton conductive resin 6 are dispersed in a solvent, such as water or alcohol. The catalyst paste is applied onto both surfaces of a proton conductive electrolyte membrane 8 or a different substrate, and then the catalyst paste is dried. In this manner, an anode 9 and a cathode 10 are formed on the proton conductive electrolyte membrane 8 or the substrate. The proton conductive electrolyte membrane 8 is held by the anode 9 and the cathode 10, and thus, a membrane/electrode assembly 7 is prepared.

In this case, mesoporous carbon particles 2 having an average crystallite size along a 002 plane of greater than or equal to 1.6 nm is used as the conductive material of one of the catalyst pastes to form the cathode 10 including the electrode catalyst layer 5. As the conductive material of the other of the catalyst pastes, mesoporous carbon particles 2, a carbon black, or the like are used to form the anode 9.

### Fourth Embodiment

According to a fourth embodiment of the present disclosure, an electrochemical device 11 includes the membrane/electrode assembly 7 of the third embodiment, as illustrated in FIG. 4. In FIG. 4, the electrochemical device 11 is formed of a single cell, which includes one cell. Alternatively, the electrochemical device 11 may be formed of a stack in which a plurality of cells is stacked.

The membrane/electrode assembly 7 is held between a pair of separators 12 and 13. The separator 12, which is one of the pair of separators 12 and 13, is disposed on the anode 9 and has a surface that faces the second surface of the first gas diffusion layer 9b (which is the surface opposite to the first electrode catalyst layer 9a-side). A supply path is disposed in the surface of the separator 12. The supply path is a path for supplying a fuel gas, such as hydrogen, to the anode 9. The separator 13, which is the other of the separators, is disposed on the cathode 10 and has a surface that faces the second surface of the second gas diffusion layer 10b (which is the surface opposite to the second electrode catalyst layer 10a-side). A supply path is disposed in the surface of the separator 13. The supply path is a path for supplying an oxidant gas, such as air, to the cathode 10.

Thus, a fuel gas and an oxidant gas supplied into the electrochemical device 11 electrochemically react with each other in the membrane/electrode assembly 7. Since the electrochemical device 11 includes the membrane/electrode assembly 7, the electrochemical device 11 has high device durability.

### Example 1

### Preparation of Electrode Catalyst and Fuel Cell

A fuel cell of Example 1 was prepared as follows. First, commercially available mesoporous carbon (CNovel, manufactured by Toyo Tanso Co., Ltd.) was heat-treated. The mesoporous carbon had a specific surface area of 1600 m²/g and a designed pore size of 10 nm. Note that methods for preparing the mesoporous carbon are not limited to a heat treatment as long as mesoporous carbon having an average crystallite size along a 002 plane of greater than or equal to 1.6 nm can be prepared.

The heat treatment was performed as follows. The mesoporous carbon was aliquoted into 1 g portions, which were placed in separate alumina crucibles. In a Tammann atmospheric furnace, the samples at room temperature were heated over a period of 2 hours and then heat-treated at 1650° C. for 2 hours. Subsequently, the samples were cooled to room temperature overnight. Accordingly, mesoporous carbon having an average crystallite size along a 002 plane of 2.2 nm was prepared. Note that the heat treatment is not limited to the described method as long as mesoporous carbon having an average crystallite size along a 002 plane of greater than or equal to 1.6 nm can be prepared.

Note that the optimal method for changing the average crystallite size depends on the type of mesoporous carbon. For example, Japanese Patent No. 6063039, which discloses a related-art technology, states that the average crystallite size remains unchanged in the mesoporous carbon before and after heat treatment.

Subsequently, the heat-treated mesoporous carbon was added to a mixed solvent containing equal amounts of water and ethanol, to prepare a slurry having a solids concentration of 1 wt. %. Zirconia beads having a diameter of 0.5 mm were added to the slurry, and the slurry was subjected to a milling process, which was performed at a peripheral speed of 12 m/s for 20 minutes in a medium-stirring type wet bead mill (Labstar Mini, manufactured by Ashizawa Finetech Ltd.). Accordingly, mesoporous carbon particles having an average particle diameter of 800 nm were prepared.

The zirconia beads were removed from the slurry that underwent the milling process, the solvent was evaporated, and subsequently, the obtained aggregates were ground in a mortar. Accordingly, dispersed mesoporous carbon particles were prepared. Note that the described method for preparing the mesoporous carbon particles is merely illustrative, and any other method may be used as long as the method can control the average crystallite size along a 002 plane and the particle diameter of the mesoporous carbon particles.

1 g of the obtained mesoporous carbon particles was added to 400 mL of a mixed solvent containing water and ethanol (in a weight ratio of 1:1), and the mixture was ultrasonically dispersed for 15 minutes. A 14 wt. % dinitrodiammine platinum nitric acid solution was added dropwise to the dispersion while the dispersion was stirred under a nitrogen atmosphere, such that an amount of platinum became 50 wt. % relative to an amount of the mesoporous carbon particles. The resultant was then heated and stirred at 80° C. for 6 hours.

The stirred mixture was naturally cooled and subsequently filtered and washed. The filtrate was dried at 80° C. for 15 hours, and, accordingly, aggregates were obtained. The aggregates were ground in a mortar and heat-treated in a gas atmosphere containing nitrogen and hydrogen (in a ratio of 85:15) at 220° C. for 2 hours. Accordingly, an electrode catalyst including mesoporous carbon particles and catalyst metal particles supported thereon was prepared. Note that the described method for preparing the electrode catalyst is merely illustrative, and any other method may be used as long as the method enables the catalyst metal particles to be supported within the mesopores of the mesoporous carbon particles.

The prepared electrode catalyst and Ketjen black (EC300J, manufactured by Lion Specialty Chemicals Co., Ltd.) were added to a mixed solvent containing equal amounts of water and ethanol, and the resultant was stirred. A weight ratio of the Ketjen black to the mesoporous carbon particles present in the electrode catalyst was 1:2. An ionomer (Nafion, manufactured by Du Pont Inc.) was added to the resulting slurry such that a weight ratio of the ionomer became 0.8 relative to a weight of the total carbon (mesoporous carbon particles and Ketjen black), and the resultant was ultrasonically dispersed. Thus, a catalyst ink was obtained, and the catalyst ink was applied to a first major surface of a solid polymer electrolyte membrane (Gore Select III, manufactured by Nippon Gore Co., Ltd.) by using a spray method, and, accordingly, a second electrode catalyst layer including the electrode catalyst was prepared.

Furthermore, a commercially available platinum-loaded carbon black catalyst (TEC10E50E, manufactured by Tanaka Kikinzoku Kogyo K.K.) was added to a mixed solvent containing equal amounts of water and ethanol, and the resultant was stirred. An ionomer (Nafion, manufactured by Du Pont Inc.) was added to the resulting slurry such that a weight ratio of the ionomer became 0.8 relative to a weight of the carbon, and the resultant was ultrasonically dispersed. Accordingly, a catalyst ink was obtained. The catalyst ink was applied to a second major surface (surface opposite to the second electrode catalyst layer-side) of the solid polymer electrolyte membrane by using a spray method, and, accordingly, a first electrode catalyst layer was prepared.

Furthermore, a first gas diffusion layer (GDL25BC, manufactured by SGL Carbon Japan Co., Ltd.) was placed on the first electrode catalyst layer, and a second gas diffusion layer (GDL25BC, manufactured by SGL Carbon Japan Co., Ltd.) was placed on the second electrode catalyst layer. The resultant was subjected to a high temperature of 140° C., and a pressure of 7 kgf/cm² was applied thereto for 5 minutes. Accordingly, a membrane/electrode assembly was prepared.

A pair of separators having a serpentine flow path was arranged to hold the resulting membrane/electrode assembly. The resultant was mounted in a specified jig, and, accordingly, a single-cell fuel cell was prepared.

### Example 2

Example 2 was carried out as follows. The same mesoporous carbon as that of Example 1 was aliquoted into 1 g portions, which were placed in separate alumina crucibles. In a Tammann atmospheric furnace, the samples at room temperature were heated over a period of 2 hours and then heat-treated at 1800° C. for 2 hours. Subsequently, the samples were cooled to room temperature overnight. Accordingly, mesoporous carbon having an average crystallite size along a 002 plane of 3.4 nm was prepared. In Example 2, the methods used to prepare the other electrode catalyst and the fuel cell were similar to those of Example 1.

### Comparative Example 1

Comparative Example 1 was carried out as follows. The same mesoporous carbon as that of Example 1 was aliquoted into 1 g portions, which were placed in separate alumina crucibles. In a Tammann atmospheric furnace, the samples at room temperature were heated over a period of 2 hours and then heat-treated at 1500° C. for 2 hours. Subsequently, the samples were cooled to room temperature overnight. Accordingly, mesoporous carbon having an average crystallite size along a 002 plane of 0.8 nm was prepared. In Comparative Example 1, the methods used to prepare the other electrode catalyst and the fuel cell were similar to those of Example 1.

### Comparative Example 2

Comparative Example 2 was carried out as follows. The same mesoporous carbon as that of Example 1 was aliquoted into 1 g portions, which were placed in separate alumina crucibles. In a Tammann atmospheric furnace, the samples at room temperature were heated over a period of 2 hours and then heat-treated at 1000° C. for 2 hours. Subsequently, the samples were cooled to room temperature overnight. Accordingly, mesoporous carbon having an average crystallite size along a 002 plane of 0.8 nm was prepared. In Comparative Example 2, the methods used to prepare the other electrode catalyst and the fuel cell were similar to those of Example 1.

### Evaluation of Electrode Catalyst and Fuel Cell

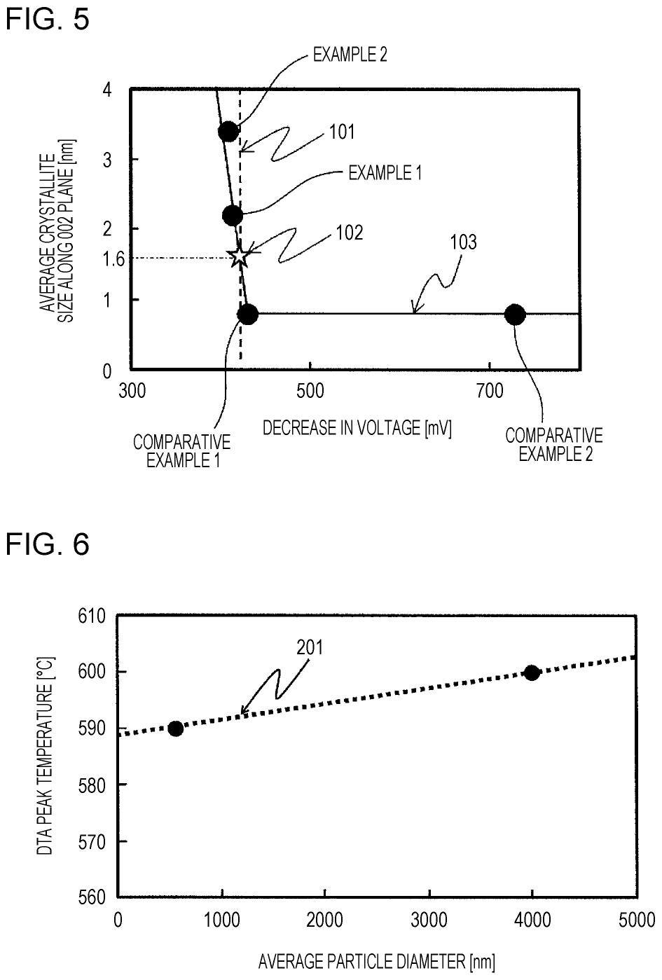

As described, mesoporous carbon particles for an electrode catalyst and fuel cells were prepared. The average crystallite size along a 002 plane, the average particle diameter, and the oxidation durability of the mesoporous carbon particles were measured as described below. In addition, a potential cycling test on the fuel cell was performed as described below. In the test, potential states for the startup and shutdown of a fuel cell were simulated. The results are shown in FIGS. 5 to 7.

The average crystallite size along a 002 plane of the mesoporous carbon particles was measured by using X-ray diffraction analysis. An X-ray diffractometer (RINT-Rapid, manufactured by Rigaku Corporation) was used, and a glass sample stage was used. The following settings were used: a tube voltage of 40 kV; a tube current of 30 mA; a projection angle of 10° (w axis); a projection time of 15 minutes; a collimator at 300 μma); and a rotational speed of 5°/minute. The average crystallite size was calculated from a (002) peak in the measurement results of the mesoporous carbon particles.

The average particle diameter of the mesoporous carbon particles was measured by using a laser diffraction particle size distribution analyzer (Microtrac HRA, manufactured by MicrotracBEL Corp.). An ionomer dispersion liquid was added to the mesoporous carbon particles such that a weight ratio of the ionomer to the carbon became 2:1. The resultant was ultrasonicated in an ultrasonic bath for 60 minutes. Accordingly, a slurry containing monodisperse mesoporous carbon particles was obtained. A particle size distribution of the slurry was measured by using laser diffractometry, and the median diameter that was determined was designated as the average particle diameter of the mesoporous carbon particles.

The oxidation durability of the mesoporous carbon particles was measured by using thermogravimetery-differential thermal analysis (TG-DTA), in which changes in the weight of the sample were continuously measured while the sample was heated in an oxygen atmosphere. A thermogravimeter-differential thermal analyzer (STA7200RV, manufactured by Hitachi High-Tech Science Corporation) was used, and a platinum measurement pan was used. The settings of the heating conditions were as follows: a temperature range of room temperature to 900° C.; a heating rate of 5° C./minute; a gas atmosphere of air; and a gas flow rate of 100 mL/minute. A DTA peak was detected from the measurement results produced by the TG-DTA method. The DTA peak temperature represents a decomposition temperature (oxidation temperature) of the mesoporous carbon particles in an oxygen atmosphere and was, therefore, used as a value for evaluating the oxidation durability of the electrode catalyst.

The potential cycling test on the fuel cell was performed as follows. The fuel cell was connected to a potentiostat/galvanostat (HAL30001, manufactured by Hokuto Denko Corporation). A temperature of the fuel cell was maintained at 80° C. Hydrogen having a dew point of 80° C. was supplied to the anode, and nitrogen having a dew point of 80° C. was supplied to the cathode. The settings for the potentiostat/galvanostat were as follows: a range of potentials to be scanned of 1 V to 1.3 V; a potential scanning speed of 0.5 V/s; and a cycle number of 5000. A voltage of the fuel cell was measured before and after the potential cycling test, in an instance in which power generation was performed with a predetermined current. The voltage before the potential cycling test was subtracted from the voltage after the potential cycling test, and the determined difference (a decrease in voltage) was used as an indicator of the electrochemical durability of the electrode catalyst.

In the graph of FIG. 5, the horizontal axis represents the decrease in voltage of the fuel cell resulting from the potential cycling test, and the vertical axis represents the average crystallite size along a 002 plane of the mesoporous carbon particles. FIG. 5 shows, as represented by black circles, the average crystallite size plotted as a function of the decrease in voltage. Based on the plot, a relationship between the average crystallite size and the decrease in voltage was determined; the relationship is represented by a solid line 103. Note that the plots shown in FIG. 5 correspond, starting from the right side, to the results of the potential cycling test performed on the fuel cells of Comparative Example 2, Comparative Example 1, Example 1, and Example 2, respectively.

The solid line 103 indicates that the smaller the average crystallite size, the greater the decrease in voltage. That is, electrode catalysts having a small average crystallite size had low electrochemical durability. A reason for this is speculated to be as follows.

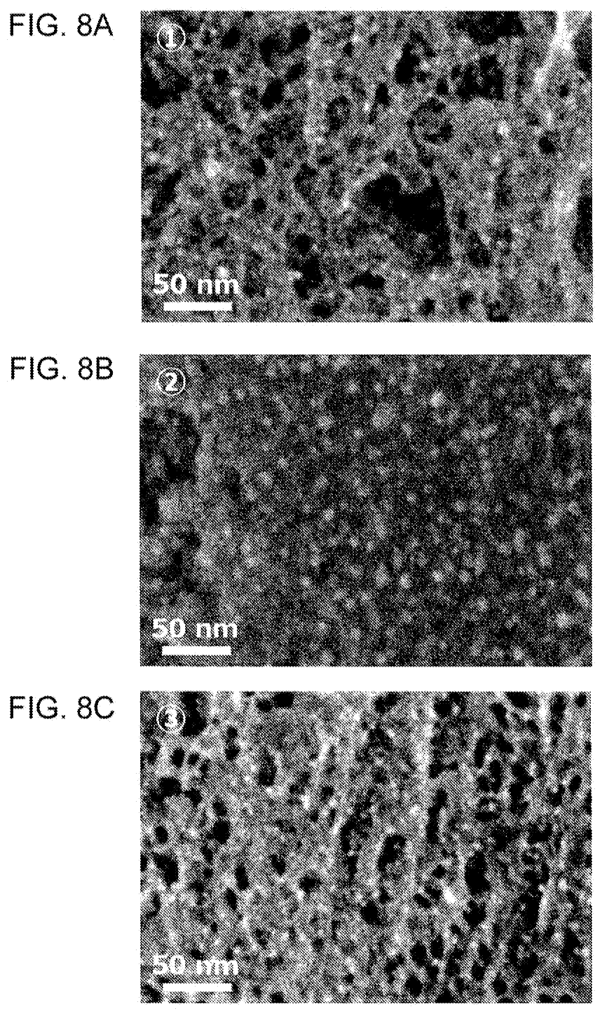

FIG. 8A is an image of a cross section of a mesoporous carbon particle of Comparative Example 2 before the potential cycling test; the mesoporous carbon particle had an average crystallite size along a 002 plane of 0.8 nm. FIG. 8B is an image of the cross section of the mesoporous carbon particle of Comparative Example 2 after the potential cycling test; the mesoporous carbon particle had an average crystallite size along a 002 plane of 0.8 nm. FIG. 8C is an image of a cross section of a mesoporous carbon particle of Example 1 after the potential cycling test; the mesoporous carbon particle had an average crystallite size along a 002 plane of 2.2 nm. Note that the image of a cross section of a mesoporous carbon particle was taken by using the following procedure. An electrode catalyst layer was milled by using a broad ion beam (BIB), a focused ion beam (FIB), or the like to expose a cross section, and an image of the cross section was captured with a scanning electron microscope (SEM).

As shown in FIG. 8B, in the mesoporous carbon particle having a small average crystallite size, a large number of mesopores were collapsed as a result of the repetition of the potential cycle, and, consequently, the catalyst metal particles within the mesopores did not function effectively. On the other hand, as shown in FIG. 8C, in the mesoporous carbon particle having a large average crystallite size, a smaller number of mesopores were collapsed than in the mesoporous carbon particle having a small average crystallite size, and, consequently, the catalyst metal particles within the mesopores functioned effectively. Thus, the smaller the average crystallite size, the greater the decrease in the voltage due to the potential cycling test.

In addition, in FIG. 5, a broken line 101 represents the decrease in voltage of a polymer electrolyte fuel cell (a typical fuel cell) that uses a carbon black, which is typically used as a support in an electrode of a fuel cell. A comparison of the broken line 101 with the solid line 103 demonstrates that when the average crystallite size along a 002 plane was greater than or equal to 1.6 nm, an electrochemical durability comparable to or higher than an electrochemical durability of a typical fuel cell was achieved, as indicated by a star symbol 102. That is, the electrode catalyst had high device durability.

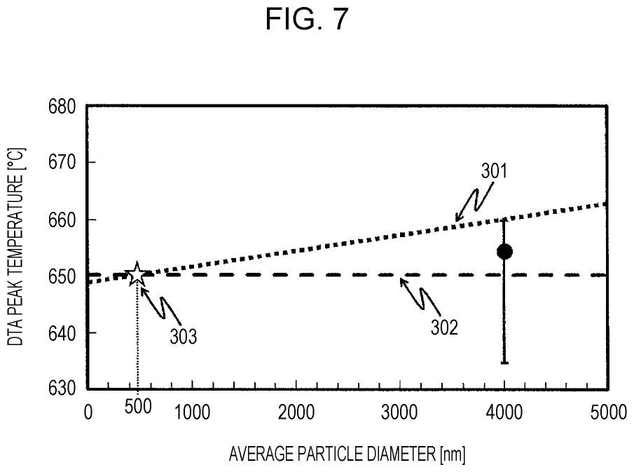

In the graphs of FIGS. 6 and 7, the horizontal axis represents the average particle diameter of the mesoporous carbon particles, and the vertical axis represents the DTA peak temperature of the mesoporous carbon particles. The black circles represent a top temperature in the DTA peak determined by the TG-DTA method mentioned above. The top temperature is a temperature at which the slope is zero.

FIG. 6 shows, as represented by black circles, the average particle diameter plotted as a function of the DTA peak temperature, regarding the mesoporous carbon particles having an average crystallite size along a 002 plane of 0.8 nm. Based on these values, a relation equation regarding the average particle diameter and the DTA peak was determined; the relation equation is represented by a dotted line 201. Furthermore, based on the slope of the relation equation, a ratio of the DTA peak temperature to the average particle diameter (DTA peak temperature/average particle diameter) was calculated.

FIG. 7 shows, as represented by a black circle, the average particle diameter plotted as a function of the DTA peak temperature, regarding the mesoporous carbon particles having an average crystallite size along a 002 plane of 2.2 nm. An error bar, which extends upward and downward from the black circle, represents temperatures corresponding to the full width at half maximum of the DTA peak.

The slope of the dotted line 201 in FIG. 6 (ratio of the DTA peak temperature to the average particle diameter) does not depend on the average crystallite size. Accordingly, by applying the slope to the DTA peak temperature of FIG. 7, a relation equation regarding the average particle diameter of the mesoporous carbon particles having an average crystallite size along a 002 plane of 2.2 nm and the DTA peak temperature thereof was determined; the relation equation is represented by a dotted line 301.

The dotted line 301 indicates that the smaller the average particle diameter of the mesoporous carbon particles, the lower the DTA peak temperature. That is, the smaller the mesoporous carbon particles, the lower the oxidation durability of the electrode catalyst.

In FIG. 7, a dashed line 302 represents a DTA peak temperature of a carbon black (a typical support), which is typically used as a support in an electrode of a fuel cell. A comparison of the dashed line 302 with the dotted line 301 demonstrates that when the average particle diameter was greater than or equal to 500 nm, as indicated by a star symbol 303, DTA peak temperatures greater than or equal to those of the typical support were achieved. Thus, in instances where an electrode catalyst included mesoporous carbon particles having an average particle diameter of greater than or equal to 500 nm, the electrode catalyst had an oxidation durability comparable to or higher than an oxidation durability of an electrode catalyst including a typical support. That is, the electrode catalyst had high device durability.

Note that from the above description, many modifications and other embodiments of the present disclosure will be apparent to those skilled in the art. Accordingly, the above description should be construed as merely illustrative. The above description is provided to teach those skilled in the art the best modes for carrying out the present disclosure. Details of structures and/or functions of the present disclosure may be substantially changed without departing from the spirit of the present disclosure.

An electrode catalyst for an electrochemical device, an electrode catalyst layer for an electrochemical device, a membrane/electrode assembly, and an electrochemical device, of the present disclosure, are useful as an electrode catalyst for an electrochemical device, an electrode catalyst layer for an electrochemical device, a membrane/electrode assembly, and an electrochemical device that have high device durability.

What is claimed is:

1. An electrode catalyst for an electrochemical device, the electrode catalyst comprising:
mesoporous carbon particles having an average crystallite size along a 002 plane of greater than or equal to 1.6 nm and less than or equal to 3.4 nm; and
catalyst metal particles supported on the mesoporous carbon particles, wherein
the mesoporous carbon particles have an average particle diameter of primary particles of greater than or equal to 500 nm.

2. The electrode catalyst for an electrochemical device according to claim 1, wherein mesopores present in the mesoporous carbon particles have a mode radius of greater than or equal to 1 nm and less than or equal to 25 nm and a pore volume of greater than or equal to 1.0 cm³/g and less than or equal to 3.0 cm³/g before the catalyst metal particles are supported on the mesoporous carbon particles.

3. An electrode catalyst layer for an electrochemical device, the electrode catalyst layer comprising:
the electrode catalyst according to claim 1; and
a proton conductive resin.

4. A membrane/electrode assembly comprising:
a proton conductive electrolyte membrane;
an anode provided on a first major surface of the proton conductive electrolyte membrane; and
a cathode provided on a second major surface of the proton conductive electrolyte membrane, wherein
at least one selected from the group consisting of the anode and the cathode includes the electrode catalyst layer according to claim 3.

5. The membrane/electrode assembly according to claim 4, wherein at least the cathode includes the electrode catalyst layer.

6. An electrochemical device comprising the membrane/electrode assembly according to claim 4.
